(19) United States
(12) Patent Application Publication
(10) Pub. No.: US 2007/0150380 A1
(43) Pub. Date: Jun. 28, 2007

(54) Integral distribution managing system and method

(75) Inventor: Chia-Chun Lee, Keelung City (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/318,457

(22) Filed: Dec. 28, 2005

(51) Int. Cl. G06Q 10/00

(52) U.S. Cl. 705/28

(57) ABSTRACT

An integral distribution managing system, which cooperates with at least one supplier terminal, at least one distributor terminal and at least one retailer terminal, includes the following modules. A supplier terminal inputs supplier information through the managing interface module. A distributor terminal inputs distributor information and a distributor trade command through the managing interface module. A retailer terminal inputs retailer information and a retailer trade command through the managing interface module. A database stores the supplier information, the distributor information and the retailer information. A distributor managing module performs a first integral transaction according to the distributor trade command, the distributor information, and the supplier information and/or the retailer information. A retailer managing module performs a second integral transaction according to the retailer trade command, the retailer information, and the supplier information and/or the distributor information.

### BACKGROUND OF THE INVENTION

1. Field of Invention

The invention relates to a distribution managing system and a distribution managing method, and, in particular, to an integral distribution managing system and an integral distribution managing method for integrating a supplier with a distributor and a retailer.

2. Related Art

In the conventional economic system, a distribution organization 12 playing an agency bridge between a supplier (or a manufacturer) 11 and a retailer 13 often exists, as shown in FIG. 1. However, the distribution organization 12 usually restrains a distribution channel 121 and the operational effectiveness of the supplier 11 is also restrained. Under the economic system, the distributor management is not normative such that the market message is opaque and the goods material inventory data cannot be controlled in a concordant manner.

Recently, the electronic transaction behaviors performed through the network grow quickly as the Internet groups are rapidly developed, such that the problem of the restrained distribution channel may be solved. The early electronic transaction mode is performed in a peer-to-peer transmission manner. That is, the enterprises perform transactions in a B2B (Business-to-Business) transmission manner.

For example, a product manufacturer communicates with a dealer in a B2B mode through individual system platforms in the prior art, so that the information, such as goods information, financial information and the like, associated with transactions may be exchanged through the Internet. Thus, the dealer can perform money flow management and proper logistics management such as purchase, sell, and stock. However, the product manufacturer has to build various B2B system platforms to cooperate with various dealers. In addition, each dealer may also build various systems with respect to different product manufacturers. Thus, the product manufacturer and the dealer encounter the expensive system building cost, which is a great load to the product manufacturer and the dealer.

In addition, one of ordinary skill in the art may also provide a B2B2B (Business-to-Business-to-Business) transaction transmission method in order to synchronize the transaction information between enterprises. However, the enterprise using the B2B2B system platform still encounters the problem of cost of building different systems, and the data access operations among different systems cannot effectively cooperate with one another. For example, the business system, such as the ERP (Enterprise Resource Management) system or the industrial SCM system used by the typical product manufacturer and the typical dealer, often limits the authority of the end user for the sake of the security consideration of the system database, and is seldom used in the Internet environment. The business system is simply used in the local network of the enterprise, so that the data among different systems cannot be effectively integrated, and the application is thus limited. At present, when the electronic business transaction is performed, the product and the money usually flow in the channel covering the supplier, the distributor and the retailer. However, the requirements of some industrial commonality have gradually appeared, and the bottlenecks of these requirements have to be effectively overcome.

Therefore, it is an important subject of the invention to provide an integral distribution managing system capable of effectively integrating the electronic transaction information of the supplier, the distributor and the retailer, and a method thereof.

### SUMMARY OF THE INVENTION

In view of the foregoing, -the invention is to provide an integral distribution managing system capable of effectively integrating electronic transaction information of a supplier, a distributor and a retailer, and a method thereof.

To achieve the above, an integral distribution managing system of the invention, which cooperates with at least one supplier terminal, at least one distributor terminal and at least one retailer terminal, includes a managing interface module, a database, a distributor managing module and a retailer managing module. In this invention, the supplier terminal inputs supplier information through the managing interface module, the distributor terminal inputs distributor information and a distributor trade command through the managing interface module, and the retailer terminal inputs retailer information and a retailer trade command through the managing interface module. The supplier information, the distributor information and the retailer information are stored in the database. The distributor managing module performs a first integral transaction according to the distributor trade command, the distributor information, and the supplier information and/or the retailer information. The retailer managing module performs a second integral transaction according to the retailer trade command, the retailer information, and the supplier information and/or the distributor information.

In addition, the invention also discloses an integral distribution managing method, which cooperates with at least one supplier terminal, at least one distributor terminal and at least one retailer terminal. The method includes the following steps of: inputting supplier information from the supplier terminal, inputting distributor information and a distributor trade command from the distributor terminal, inputting retailer information and a retailer trade command from the retailer terminal, and performing a first integral transaction or a second integral transaction. In the invention, the first integral transaction is performed according to the distributor trade command, the distributor information, and the supplier information and/or the retailer information. The second integral transaction is performed according to the retailer trade command, the retailer information, and the supplier information and/or the distributor information.

In summary, the integral distribution managing system and method of the invention provide an integral interface through the Internet. Thus, the supplier, the distributor and the retailer can respectively transfer the information associated with the to-be-performed transaction to the integral distribution managing system through the supplier terminal, the distributor terminal and the retailer terminal, and then perform an integral transaction in the integral distribution managing system. Therefore, the electronic transaction information of the supplier, the distributor and the retailer can be effectively integrated. Compared to the prior art, each of the supplier, the distributor and the retailer only needs a terminal device to access the integral distribution managing system of the invention through the Internet, and to perform the desired transaction or other information transferring procedures. Thus, the system build-up cost can be reduced, and the cost load of the supplier, the distributor or the retailer may be reduced. In addition, the electronic transaction information of the supplier, the distributor and the retailer may be effectively integrated into the integral distribution managing system of the invention. As a result, it is possible to prevent the data from being dispersed over various channels in the conventional B2B2B mode, in which the data cannot be effectively integrated.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a distribution organization composed of a supplier, a manufacturer and a retailer in a conventional economic system;

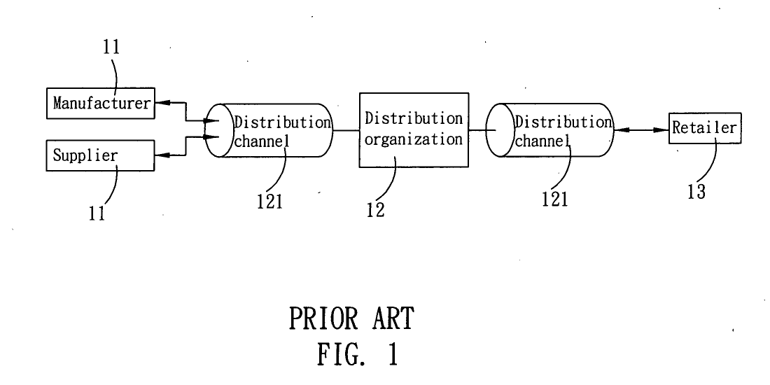

FIG. 2 is a schematic illustration showing an integral distribution managing system according to a preferred embodiment of the invention; and

FIG. 3 is a flow chart of an integral distribution managing method according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

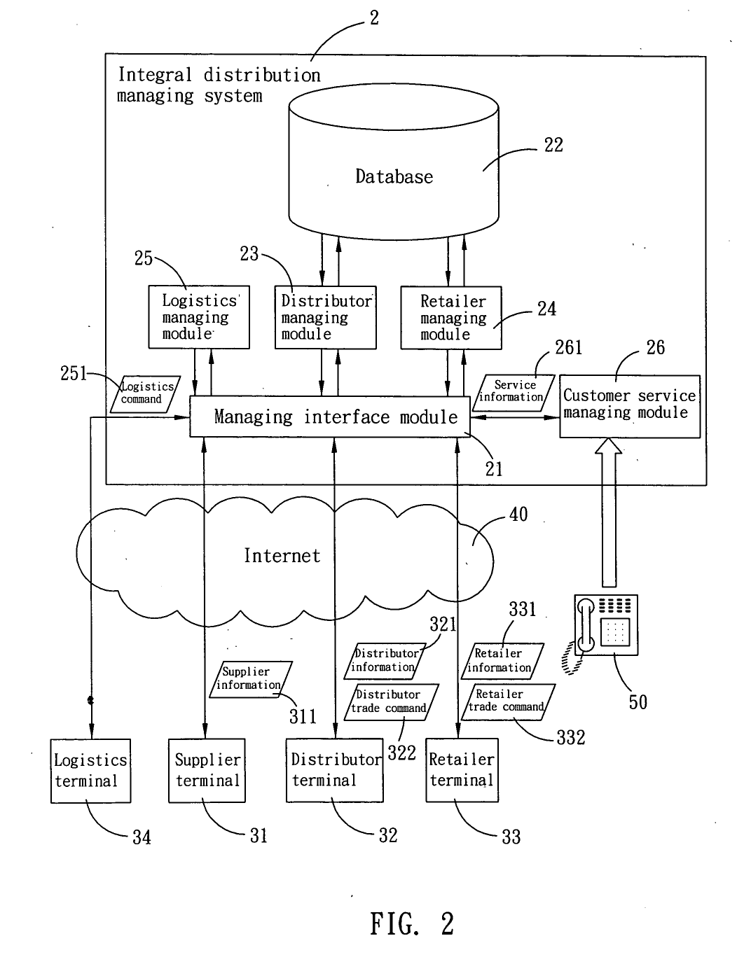

Referring to FIG. 2, an integral distribution managing system 2 according to a preferred embodiment of the invention cooperates with at least one supplier terminal 31, at least one distributor terminal 32 and at least one retailer terminal 33, and includes a managing interface module 21, a database 22, a distributor managing module 23 and a retailer managing module 24. In addition, the integral distribution managing system 2 may further include a logistics managing module 25 and a customer service managing module 26.

The supplier terminal 31 inputs supplier information 311 through the managing interface module 21. The distributor terminal 32 inputs distributor information 321 and a distributor trade command 322 through the managing interface module 21. The retailer terminal 33 inputs retailer information 331 and a retailer trade command 332 through the managing interface module 21. In this embodiment, each of the supplier terminal 31, the distributor terminal 32 and the retailer terminal 33 is a terminal device, such as a desktop computer, which is connected to the integral distribution managing system 2 through Internet 40. The supplier terminal 31, the distributor terminal 32 and the retailer terminal 33 are respectively disposed at a supplier, a distributor and a retailer. The supplier information 311 includes product inventory data, product promotion data, financial data and customer data corresponding to the supplier. The distributor information 321 includes product inventory data, product promotion data, financial data and customer data corresponding to the distributor. The retailer information 331 includes product inventory data, product promotion data, financial data and customer data corresponding to the retailer.

The database 22 stores the information, such as the supplier information 311, the distributor information 321 and the retailer information 331. In this embodiment, the database 22 may be any suitable electronic database, such as the MS-SQL database, the Oracle database, or the likes.

Referring to FIG. 2, the distributor managing module 23 performs a first integral transaction according to the distributor trade command 322, the distributor information 321 and the supplier information 311 and/or the retailer information 331. In addition, the retailer managing module 24 performs a second integral transaction according to the retailer trade command 332, the retailer information 331 and the supplier information 311 and/or the distributor information 321.

To be noted, the product requirement usually arises from the distributor and the retailer in the economic system containing the supplier, the distributor and the retailer, and the product supply arises from the supplier and the distributor. Under this supply-demand structure, it is possible to output a trade command from the distributor to the supplier or the retailer so as to perform the transaction between the distributor and the supplier, the transaction between the distributor and the retailer, or even the transactions among the distributor, the supplier and the retailer. The types of these transactions are integrated in the first integral transaction. In addition, it is also possible to output the trade command from the retailer to the supplier or the distributor so as to perform the transaction between the retailer and the distributor, the transaction between the supplier and the supplier, or even the transactions among the retailer, the distributor and the supplier. The types of these transactions are integrated in the second integral transaction.

In addition, the logistics managing module 25 receives the first integral transaction or the second integral transaction through the managing interface module 21, and generates a logistics command 251 according to the first integral transaction or the second integral transaction. In this embodiment, the integral distribution managing system 2 further cooperates with at least one logistics terminal 34. In this case, the logistics command 251 is transferred to the logistics terminal 34 through the managing interface module 21. Thus, the logistics supplier can obtain the demand on the product logistics through the logistics terminal 34 so as to arrange a suitable transportation tool in conjunction with the shipping plan of the supplier or the distributor.

Furthermore, the customer service managing module 26 receives service information 261 through a telephone system 50. In this embodiment, the service information 261 is transferred to the supplier terminal 31, the distributor terminal 32 or the retailer terminal 33 through the managing interface module 21. Thus, the supplier, the distributor or the retailer can be the instant response of an end user through the supplier terminal 31, the distributor terminal 32 or the retailer terminal 33 so as to improve the product or eliminate the drawback of the product, and to enhance the commercial competition ability.

To make the invention more comprehensive, the operation of the integral distribution managing system according to the preferred embodiment of the invention will be described hereinafter.

As shown in FIG. 2, when the distributor trade command 322 is received, the distributor managing module 23 performs the first integral transaction. At this time, transaction goods data of the first integral transaction is transferred to the supplier terminal 31 through the managing interface module 21, and transaction amount data of the first integral transaction is transferred to the distributor terminal 32 through the managing interface module 21. Thereafter, when the supplier replies a charge-received confirmation message through the supplier terminal 31 and the distributor replies a goods-received confirmation message through the distributor terminal 32, the distributor managing module 23 judges that the first integral transaction is finished. The transaction goods data, the transaction amount data, the charge-received confirmation message and the goods-received confirmation message are stored in the database 22. Thus, the end user, such as the supplier, the distributor or the retailer, can do the business statistics. For example, the distributor managing module 23 may further generate distributor managing statistical data according to the transaction goods data, the transaction amount data and the distributor information, and transfer the distributor managing statistical data to the distributor terminal 32 through the managing interface module 21. Thus, the distributor can find associated business records at the distributor terminal 32. In addition, when the distributor replies the goods-received confirmation message through the distributor terminal 32, the distributor terminal 32 can generate a confirmation voucher to serve as the confirmation note for the goods warehouse. Correspondingly, the supplier can output a shipment confirmation message through the supplier terminal 31 while performing a shipment operation of goods, and the supplier terminal 31 can generate a confirmation voucher to serve as the confirmation note for the goods shipment.

Moreover, when the first integral transaction is performed, the transaction goods data of the first integral transaction may also be transferred to the distributor terminal 32 through the managing interface module 21, and the transaction amount data of the first integral transaction is transferred to the retailer terminal 33 through the managing interface module 21. Thereafter, when the distributor terminal 32 replies a charge-received confirmation message and the retailer terminal 33 replies a goods-received confirmation message, the distributor managing module 23 judges that the first integral transaction is finished. The transaction goods data, the transaction amount data, the charge-received confirmation message and the goods-received confirmation message are stored in the database 22, such that the end user, such as the supplier, the distributor or the retailer, can make the business statistics. For example, the distributor managing module 23 may further generate distributor managing statistical data according to the transaction goods data, the transaction amount data and the distributor information, and transfer the distributor managing statistical data to the distributor terminal 32 through the managing interface module 21. In addition, the retailer managing module 24 can generate retailer managing statistical data according to the transaction goods data, the transaction amount data and the retailer information, and transfer the retailer managing statistical data to the retailer terminal 33 through the managing interface module 21. Thus, the distributor and the retailer may find the associated business records at the distributor terminal 32 and the retailer terminal 33. Besides, the retailer terminal 33 can generate a confirmation voucher to serve as the confirmation note for the goods warehouse while replying the goods-received confirmation message through the retailer terminal 33. Correspondingly, the distributor can output the shipment confirmation message through the distributor terminal 32 while performing the shipment operation of goods, and the distributor terminal 32 can generate a confirmation voucher to serve as the confirmation note for the goods shipment.

In addition, the retailer managing module 24 performs the second integral transaction when it receives the retailer trade command 332, as shown in FIG. 2. At this time, transaction goods data of the second integral transaction is transferred to the distributor terminal 32 through the managing interface module 21, and transaction amount data of the second integral transaction is transferred to the retailer terminal 33 through the managing interface module 21. Thereafter, when the distributor replies a charge-received confirmation message through the distributor terminal 32 and the retailer replies a goods-received confirmation message through the retailer terminal 33, the retailer managing module 24 judges that the second integral transaction is finished. The transaction goods data, the transaction amount data, the charge-received confirmation message and the goods-received confirmation message are stored in the database 22, such that the end user, such as the supplier, the distributor or the retailer can do the business statistics. For example, the retailer managing module 24 generates retailer managing statistical data according to the transaction goods data, the transaction amount data and the retailer information, and transfers the retailer managing statistical data to the retailer terminal 33 through the managing interface module 21. The distributor managing module 23 generates distributor managing statistical data according to the transaction goods data, the transaction amount data and the distributor information, and transfers the distributor managing statistical data to the distributor terminal 32 through the managing interface module 21. Thus, the distributor and the retailer can find the associated business records at the distributor terminal 32 and the retailer terminal 33. In addition, when the retailer replies the goods-received confirmation message through the retailer terminal 33, the retailer terminal 33 can generate a confirmation voucher to serve as the confirmation note for the goods warehouse. Correspondingly, the distributor can output the shipment confirmation message through the distributor terminal 32 while performing the shipment operation of goods, and the distributor terminal 32 can generate a confirmation voucher to serve as the confirmation note for the goods shipment.

As mentioned hereinabove, the distributor managing module 23 may further generate a suggested transaction goods amount according to a safety inventory amount and a current inventory amount of the distributor information, and transfer the suggested transaction goods amount to the distributor terminal 32 through the managing interface module 21. In more detailed, when the above-mentioned second integral transaction is finished, the goods inventory amount (i.e., the current inventory amount) of the distributor is decreased. At this time, the suggested transaction goods amount generated by the distributor managing module 23 may be transferred to the distributor terminal 32. Therefore, the distributor may be timely reminded to perform the above-mentioned first integral transaction and to keep the goods inventory amount greater than the safety inventory amount. Accordingly, the distributor managing module 23 can effectively assist the distributor in performing the control and the management of the goods inventory.

In brief, the integral distribution managing system 2 according to the preferred embodiment of the invention can assist the distributor in performing the purchase management, the sale management, the warehouse management, the financial management and the retailer management, as well as assist the retailer in performing the purchase management, the sale management, the financial management, the system management. In addition, the integral distribution managing system 2 may also assist the logistics supplier in performing the purchase-sale-stock management, the warehouse management and the transportation management. Furthermore, the integral distribution managing system 2 may further provide various functions, such as various products or promotion messages, the database management, and the on-line transaction management for each end user.

Of course, the integral distribution managing system 2 may further include other integral managing functions. For example, the system 2 can generate salesman information according to the retailer information and then transfer the salesman information through the managing interface module 21 to at least one salesman terminal (not shown). Accordingly, the salesman can receive the salesman information through the salesman terminal so as to obtain the market message and the promotion message and perform the sales path arrangement, the order management, the inventory management, or the likes.

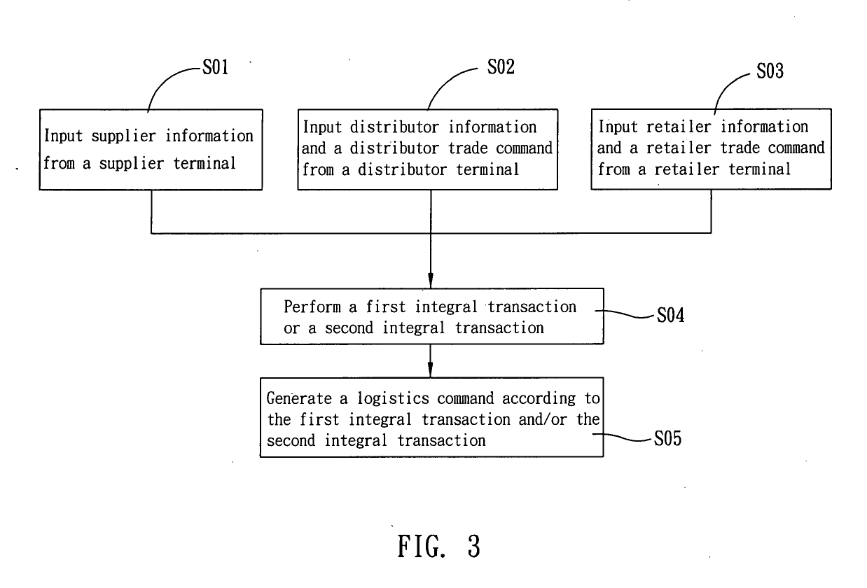

In addition, as shown in FIG. 3, an integral distribution managing method according to the preferred embodiment of the invention is applied to the integral distribution managing system 2, and includes the following steps.

First, the step S01 inputs supplier information from a supplier terminal. The supplier information includes the product inventory data, product promotion data, financial data and customer data corresponding to a supplier.

The step S02 inputs distributor information and a distributor trade command from a distributor terminal. The distributor information includes product inventory data, product promotion data, financial data and customer data corresponding to a distributor.

The step S03 inputs retailer information and a retailer trade command from a retailer terminal. The retailer information includes product inventory data, product promotion data, financial data and customer data corresponding to a retailer.

Next, the step S04 performs a first integral transaction or a second integral transaction. In this step S04, the first integral transaction is performed according to the distributor trade command, the distributor information and the supplier information and/or the retailer information, and the second integral transaction is performed according to the retailer trade command, the retailer information and the supplier information and/or the distributor information. The detailed descriptions of the first integral transaction and the second integral transaction have been mentioned hereinabove, and will thus be omitted.

Then, the step S05 generates a logistics command according to the first integral transaction and/or the second integral transaction. The logistics command is transferred to a logistics terminal such that the logistics supplier performs associated operations, such as the arrangement of the transportation tool of the goods, according to this logistics command.

In addition, the integral distribution managing method according to the invention may further include the steps of: inputting service information received through a telephone system, and transferring the service information to the supplier terminal, the distributor terminal, and/or the retailer terminal. In addition, the integral distribution managing method of this invention may further include the steps of: generating a suggested transaction goods amount according to a safety inventory amount and a current inventory amount of the distributor information, and transferring the suggested transaction goods amount to the distributor terminal. The above-mentioned steps can be performed by the modules of the integral distribution managing system 2, and the detailed descriptions thereof will be omitted.

In summary, the integral distribution managing system and method of the invention provide an integral interface through the Internet. Thus, the supplier, the distributor and the retailer can respectively transfer the information associated with the to-be-performed transaction to the integral distribution managing system through the supplier terminal, the distributor terminal and the retailer terminal, and then perform an integral transaction in the integral distribution managing system. Therefore, the electronic transaction information of the supplier, the distributor and the retailer can be effectively integrated. Compared to the prior art, each of the supplier, the distributor and the retailer only needs a terminal device to access the integral distribution managing system of the invention through the Internet, and to perform the desired transaction or other information transferring procedures. Thus, the system build-up cost can be reduced, and the cost load of the supplier, the distributor or the retailer may be reduced. In addition, the electronic transaction information of the supplier, the distributor and the retailer may be effectively integrated into the integral distribution managing system of the invention. As a result, it is possible to prevent the data from being dispersed over various channels in the conventional B2B2B mode, in which the data cannot be effectively integrated.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An integral distribution managing system, which cooperates with at least one supplier terminal, at least one distributor terminal and at least one retailer terminal, the system comprising:
a managing interface module, wherein the supplier terminal inputs supplier information through the managing interface module, the distributor terminal inputs distributor information and a distributor trade command through the managing interface module, and the retailer terminal inputs retailer information and a retailer trade command through the managing interface module;
a database for storing the supplier information, the distributor information and the retailer information;
a distributor managing module for performing a first integral transaction according to the distributor trade command, the distributor information, and at least one of the supplier information and the retailer information; and
a retailer managing module for performing a second integral transaction according to the retailer trade command, the retailer information, and at least one of the supplier information and the distributor information.

2. The integral distribution managing system according to claim 1, wherein the managing interface module connects to the supplier terminal, the distributor terminal and the retailer terminal through Internet.

3. The integral distribution managing system according to claim 1, further comprising:
a logistics managing module for receiving the first integral transaction or the second integral transaction through the managing interface module, and generating a logistics command according to the first integral transaction or the second integral transaction, wherein the integral distribution managing system further cooperates with at least one logistics terminal, and the logistics command is transferred to the logistics terminal through the managing interface module.

4. The integral distribution managing system according to claim 1, further comprising:
a customer service managing module for receiving service information through a telephone system, wherein the service information is transferred to one of the supplier terminal, the distributor terminal and the retailer terminal through the managing interface module.

5. The integral distribution managing system according to claim 1, wherein:
when the first integral transaction is performed, transaction goods data of the first integral transaction is transferred to the supplier terminal through the managing interface module, and transaction amount data of the first integral transaction is transferred to the distributor terminal through the managing interface module;
when the supplier terminal replies a charge-received confirmation message and the distributor terminal replies a goods-received confirmation message, the distributor managing module judges that the first integral transaction is finished;
the transaction goods data, the transaction amount data, the charge-received confirmation message and the goods-received confirmation message are stored in the database; and
the distributor managing module generates distributor managing statistical data according to the transaction goods data, the transaction amount data and the distributor information, and transfers the distributor managing statistical data to the distributor terminal through the managing interface module.

6. The integral distribution managing system according to claim 1, wherein:
when the first integral transaction is performed, transaction goods data of the first integral transaction is transferred to the distributor terminal through the managing interface module, and transaction amount data of the first integral transaction is transferred to the retailer terminal through the managing interface module;
when the distributor terminal replies a charge-received confirmation message and the retailer terminal replies a goods-received confirmation message, the distributor managing module judges that the first integral transaction is finished;
the distributor managing module generates distributor managing statistical data according to the transaction goods data, the transaction amount data and the distributor information, and transfers the distributor managing statistical data to the distributor terminal through the managing interface module; and
the retailer managing module generates retailer managing statistical data according to the transaction goods data, the transaction amount data and the retailer information, and transfers the retailer managing statistical data to the retailer terminal through the managing interface module.

7. The integral distribution managing system according to claim 1, wherein:
when the second integral transaction is performed, transaction goods data of the second integral transaction is transferred to the distributor terminal through the managing interface module, and transaction amount data of the second integral transaction is transferred to the retailer terminal through the managing interface module;
when the distributor terminal replies a charge-received confirmation message and the retailer terminal replies a goods-received confirmation message, the retailer managing module judges that the second integral transaction is finished;
the retailer managing module generates retailer managing statistical data according to the transaction goods data, the transaction amount data and the retailer information, and transfers the retailer managing statistical data to the retailer terminal through the managing interface module; and
the distributor managing module generates distributor managing statistical data according to the transaction goods data, the transaction amount data and the distributor information, and transfers the distributor managing statistical data to the distributor terminal through the managing interface module.

8. The integral distribution managing system according to claim 1, wherein the distributor managing module generates a suggested transaction goods amount according to a safety inventory amount and a current inventory amount of the distributor information, and transfers the suggested transaction goods amount to the distributor terminal through the managing interface module.

9. The integral distribution managing system according to claim 1, wherein:
the supplier information comprises product inventory data, product promotion data, financial data and customer data corresponding to a supplier;
the distributor information comprises product inventory data, product promotion data, financial data and customer data corresponding to a distributor; and
the retailer information comprises product inventory data, product promotion data, financial data and customer data corresponding to a retailer.

10. An integral distribution managing method, which cooperates with at least one supplier terminal, at least one distributor terminal and at least one retailer terminal, the method comprising the steps of:
inputting supplier information from the supplier terminal;
inputting distributor information and a distributor trade command from the distributor terminal;
inputting retailer information and a retailer trade command from the retailer terminal; and
performing a first integral transaction or a second integral transaction, wherein the first integral transaction is performed according to the distributor trade command, the distributor information, and at least one of the supplier information and the retailer information, and the second integral transaction is performed according to the retailer trade command, the retailer information, and at least one of the supplier information and the distributor information.

11. The method according to claim 10, wherein the supplier terminal, the distributor terminal and the retailer terminal output and receive data through Internet.

12. The method according to claim 10, further comprising:
generating a logistics command according to the first integral transaction or the second integral transaction.

13. The method according to claim 12, further cooperating with at least one logistics terminal, wherein the logistics command is transferred to the logistics terminal.

14. The method according to claim 10, further comprising:
inputting service information through a telephone system; and
transferring the service information to one of the supplier terminal, the distributor terminal and the retailer terminal.

15. The method according to claim 10, wherein to perform the first integral transaction comprises the following steps of:
transferring transaction goods data of the first integral transaction to the supplier terminal;
transferring transaction amount data of the first integral transaction to the distributor terminal; and
judging that the first integral transaction is finished when the supplier terminal replies a charge-received confirmation message and the distributor terminal replies a goods-received confirmation message;
generating distributor managing statistical data according to the transaction goods data, the transaction amount data and the distributor information; and
transferring the distributor managing statistical data to the distributor terminal.

16. The method according to claim 10, wherein to perform the first integral transaction comprises the following steps of:
transferring transaction goods data of the first integral transaction to the distributor terminal;
transferring transaction amount data of the first integral transaction to the retailer terminal;
judging that the first integral transaction is finished when the distributor terminal replies a charge-received confirmation message and the retailer terminal replies a goods-received confirmation message;
generating distributor managing statistical data according to the transaction goods data, the transaction amount data and the distributor information;
transferring the distributor managing statistical data to the distributor terminal;
generating retailer managing statistical data according to the transaction goods data, the transaction amount data and the retailer information; and
transferring the retailer managing statistical data to the retailer terminal.

17. The method according to claim 10, wherein to perform the second integral transaction comprises the following steps of:
transferring transaction goods data of the second integral transaction to the distributor terminal;
transferring transaction amount data of the second integral transaction to the retailer terminal;
judging that the second integral transaction is finished when the distributor terminal replies a charge-received confirmation message and the retailer terminal replies a goods-received confirmation message;
generating retailer managing statistical data according to the transaction goods data, the transaction amount data and the retailer information;
transferring the retailer managing statistical data to the retailer terminal;
generating distributor managing statistical data according to the transaction goods data, the transaction amount data and the distributor information; and transferring the distributor managing statistical data to the distributor terminal.

18. The method according to claim 10, further comprising:
generating a suggested transaction goods amount according to a safety inventory amount and a current inventory amount of the distributor information; and
transferring the suggested transaction goods amount to the distributor terminal.

19. The method according to claim 10, wherein:
the supplier information comprises product inventory data, product promotion data, financial data and customer data corresponding to a supplier;
the distributor information comprises product inventory data, product promotion data, financial data and customer data corresponding to a distributor; and
the retailer information comprises product inventory data, product promotion data, financial data and customer data corresponding to a retailer.
